(19) United States
(12) Patent Application Publication
(10) Pub. No.: US 2020/0340858 A1
(43) Pub. Date: Oct. 29, 2020

(54) PLASMA EMISSION MONITORING SYSTEM WITH CROSS-DISPERSION GRATING

(71) Applicant: Applied Materials, Inc., Santa Clara, CA (US)

(72) Inventors: Philip Allan Kraus, San Jose, CA (US); Kelvin Chan, San Ramon, CA (US); Travis Koh, Sunnyvale, CA (US); Blake Erickson, Gilroy, CA (US); Upendra Ummethala, Cupertino, CA (US)

(21) Appl. No.: 16/828,609

(22) Filed: Mar. 24, 2020

Related U.S. Application Data
(60) Provisional application No. 62/837,929, filed on Apr. 24, 2019.

(51) Int. Cl. G01J 3/18; G02B 6/42; G01J 3/02

(52) U.S. Cl. CPC G01J 3/1809; G01J 2003/1213; G01J 3/0218; G02B 6/4215

(57) ABSTRACT

Embodiments disclosed herein include an optical sensor system. In an embodiment, the optical sensor system comprises a processing chamber and a sensor. In an embodiment, the sensor comprises a first diffraction grating oriented in a first direction, a second diffraction grating oriented in a second direction, and a detector for detecting electromagnetic radiation diffracted from the first grating and the second grating. In an embodiment, the optical sensor system further comprises an optical coupling element, where the optical coupling element optically couples an interior of the processing chamber to the sensor.

This application claims the benefit of U.S. Provisional Application No. 62/837,929, filed on Apr. 24, 2019, the entire contents of which are hereby incorporated by reference herein.

### BACKGROUND

### 1) Field

Embodiments relate to the field of semiconductor manufacturing and, in particular, to systems for providing high resolution optical monitoring of plasma conditions.

### 2) Description of Related Art

Currently existing optical emission spectroscopy (OES) systems used in semiconductor manufacturing are limited. Particularly, existing OES systems have insufficient resolution to observe individual lines of an emission spectrum. This leads to emission spectra that includes line overlap and leads to a blurring of the spectrum. For example, existing OES systems have an approximately 1 nm resolution. This is too large to observe distinct atomic or molecular optical transitions. Accordingly, a typical peak in a spectra observed using an existing OES system may be comprised of a plurality of individual peaks, and some peaks are not observable at all because of line overlap with such a wide instrument resolution. Therefore, physical interpretation of the emission spectra to extract physical information (e.g., species densities and gas temperature) is not possible, and OES analysis is currently limited to only empirical observations.

### SUMMARY

Embodiments disclosed herein include an optical sensor system. In an embodiment, the optical sensor system comprises a processing chamber and a sensor. In an embodiment, the sensor comprises a first diffraction grating oriented in a first direction, a second diffraction grating oriented in a second direction, and a detector for detecting electromagnetic radiation diffracted from the first grating and the second grating. In an embodiment, the optical sensor system further comprises an optical coupling element, where the optical coupling element optically couples an interior of the processing chamber to the sensor.

In an additional embodiment, an optical sensor system is disclosed. In an embodiment, the optical sensor system comprises an optical coupling element and a sensor that is optically coupled to the optical coupling element. In an embodiment, the sensor comprises, a first diffraction grating oriented in a first direction, a second diffraction grating oriented in a second direction, where the second direction is substantially orthogonal to the first direction, and a detector for detecting electromagnetic radiation diffracted from the first grating and the second grating.

Additional embodiments disclosed herein include a method of analyzing plasma characteristics. In an embodiment, the method comprises obtaining an spectral plot of electromagnetic radiation emitted by a plasms in a processing chamber, where the spectral plot has a resolution of approximately 10 pm or lower, and comparing the spectral plot to spectral plot models, where the spectral plot models are each correlated to at least one plasma characteristic. In an embodiment, the method may further comprise selecting the spectral plot model that most closely matches the obtained spectral plot, and using at least one of the associated plasma characteristics or spectral events in a feedback mechanism to modify the processing in the processing chamber.

### BRIEF DESCRIPTION OF THE DRAWINGS

FIG. 1 is a block diagram of a processing system with an optical sensor system with a cross-dispersion grating for use in semiconductor manufacturing, in accordance with an embodiment.

FIG. 2A is a partial perspective view of a processing system with an optical sensor system with an optical coupling element that is a window through the chamber, in accordance with an embodiment.

FIG. 2B is a partial perspective view of a processing system with an optical sensor system with an optical coupling element that is a fiber optic cable, in accordance with an embodiment.

FIG. 2C is a partial perspective view of a processing system with an optical sensor system with an optical coupling element that is a fiber optic switching element, in accordance with an embodiment.

FIG. 2D is a partial perspective view of a processing system with a plurality of processing chambers that are optically coupled to sensor with a fiber optic switching element, in accordance with an embodiment.

FIG. 2E is a partial perspective view of a processing system with an optical sensor system with an optical coupling element that comprises a plurality of filters, in accordance with an embodiment.

FIG. 3 is a schematic of a cross-dispersion grating that may be used in an optical sensor system for semiconductor fabrication, in accordance with an embodiment.

FIG. 4 is a cross-sectional illustration of a processing tool that comprises an optical sensor system with variable optics that allows for sensing various locations within the processing chamber, in accordance with an embodiment.

FIG. 5 is a block diagram of an optical sensor system that includes a trigger switch between the chamber and the cross-dispersion grating, in accordance with an embodiment.

FIG. 6 is a pair of optical spectrums obtained by an optical sensor system with a cross-dispersion grating and a traditional spectrometer, in accordance with an embodiment.

FIG. 7 is a flow diagram of a process for obtaining and utilizing a spectral plot to determine plasma characteristics.

FIG. 8 illustrates a block diagram of an exemplary computer system that may be used in conjunction with an optical sensor system, in accordance with an embodiment.

### DETAILED DESCRIPTION

Systems and methods described herein include high resolution optical emission spectroscopy (OES) systems for providing plasma monitoring. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

As noted above, currently available OES systems are not capable of providing the needed resolution that enables interpretation of the emission spectra to extract physical information (e.g., species densities and gas temperature). Accordingly, embodiments disclosed herein include an OES system that utilizes a cross-dispersion grating. The use of a cross-dispersion grating allows for improved resolution. Particularly, embodiments disclosed herein allow for resolutions of approximately 10 pm or smaller. In some embodiments, the cross-dispersion grating may allow for resolutions of approximately 100 fm or smaller. The ability to provide such small resolutions allows for unobstructed observation of individual atomic or molecular optical transitions. For these high resolution spectra, all emitting species are observed and physical information can be extracted. Accordingly, embodiments allow for physical information of the plasma (e.g., species densities and gas temperatures) to be provided. This additional information provides greater control of processing conditions and allows for improved processing uniformity.

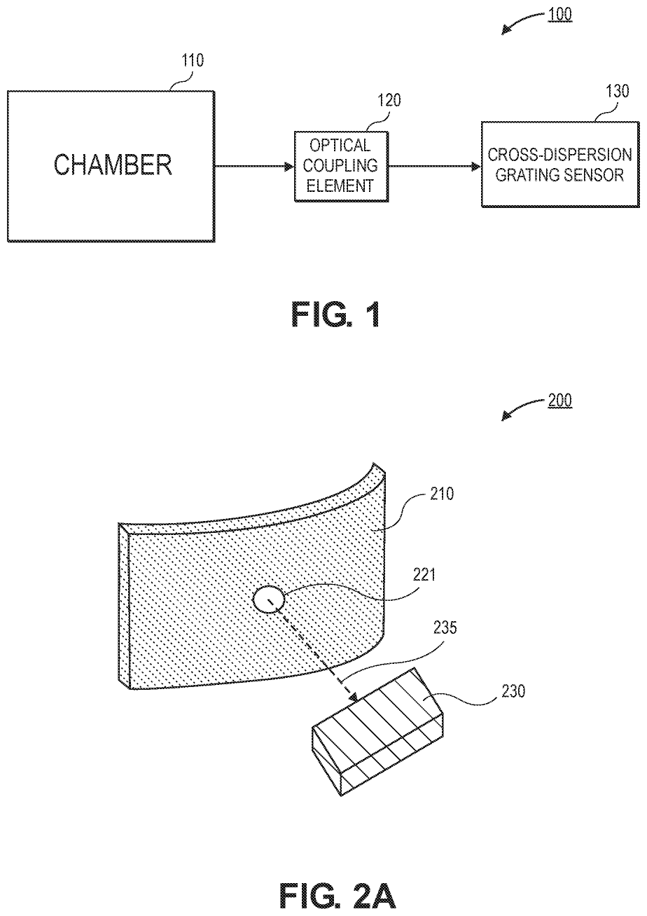

Referring now to FIG. 1, a block diagram of a plasma processing system 100 with an OES system is shown, in accordance with an embodiment. In an embodiment, the plasma processing system 100 may comprise a chamber 110, and optical coupling element 120, and a cross-dispersion grating sensor 130. As used herein, the cross-dispersion grating system 130 may also be referred to as a “sensor” for brevity. In some embodiments, the chamber 110 may be any suitable chamber for semiconductor manufacturing. For example, the chamber 110 may comprise a chamber suitable for generating a plasma in order to process one or more substrates (not shown) within the chamber 110. In an embodiment, the plasma may be generated with any suitable plasma generation technique (e.g., capacitively coupled plasma (CCP) source, a remote plasma source (RPS), a microwave plasma source, an inductively coupled plasma (ICP) source, or the like).

In an embodiment, the optical emissions from the plasma may be optically coupled to the sensor 130 by an optical coupling element 120. In some embodiments, the optical coupling element 120 comprises an optical path that guides emissions from the plasma to the sensor 130. In other embodiments, the optical coupling element 120 may also modify the optical emissions from the plasma (e.g., with a filter or the like).

As shown, the sensor 130 is used as the sensing element in the OES system. The sensor 130 is illustrated as a single block, but it is to be appreciated that the sensor 130 may comprise a first diffraction grating, a second diffraction grating, and a detector. For example, the first diffraction grating and the second diffraction grating may be oriented so that the grating directions are substantially orthogonal to each other. In an embodiment, the detector may comprise any suitable detector (e.g., charged coupled device (CCD), a charge injection device (CID) or the like). The sensor 130 may also comprise mirrors and/or lenses for focusing the optical emissions.

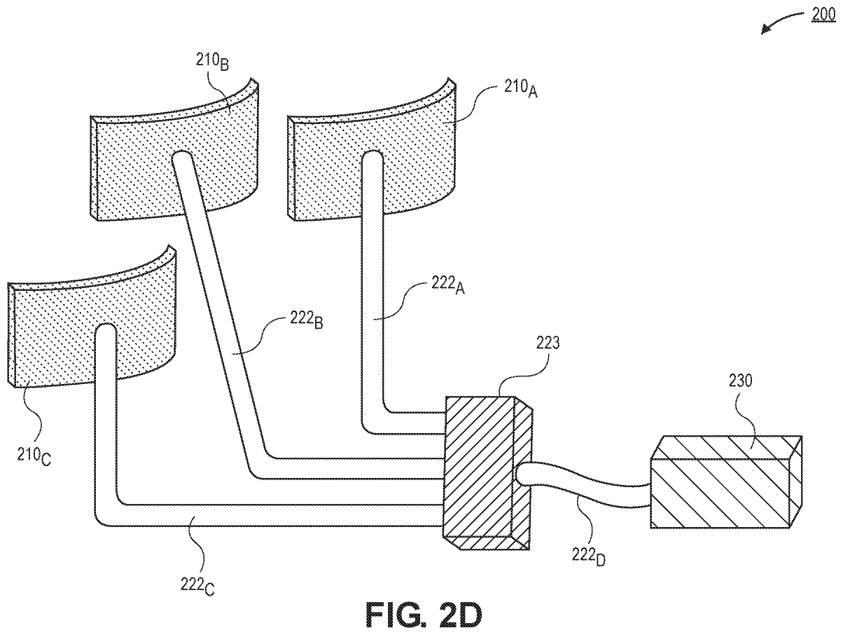

The use of a cross-dispersion grating sensor 130 provides improved resolution compared to typical OES systems that utilize a spectrometer with a single dispersion grating. The cross-dispersion grating allows for higher diffraction orders to be sensed. This allows for increased dispersion of spectral features at the detector, and enables increased differentiation of the features in the spectra. A more detailed description of the sensor 130 is provided below with respect to FIG. 3.

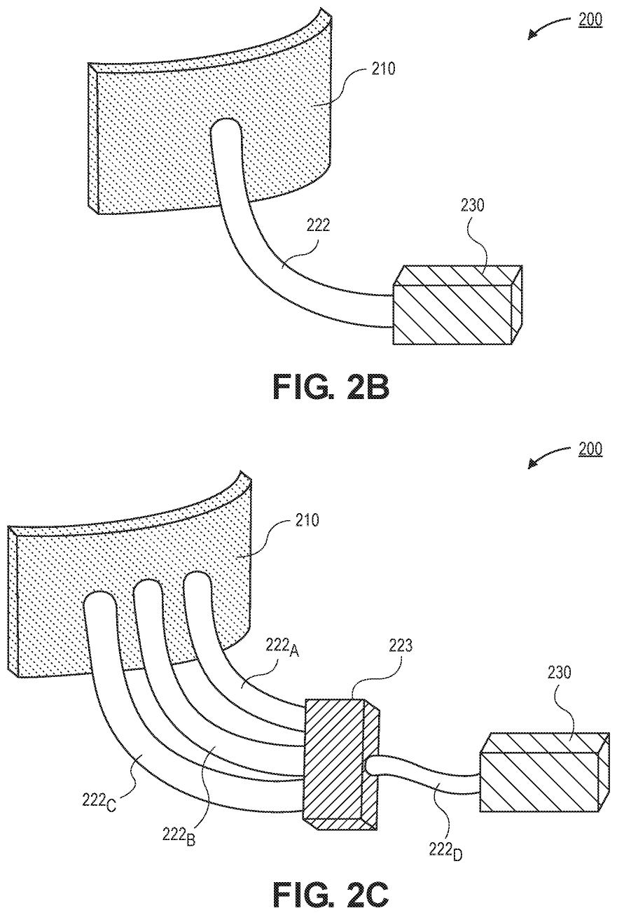

Referring now to FIG. 2A, a partial perspective view of a plasma processing system 200 is shown, in accordance with an embodiment. In an embodiment, the plasma processing system 200 may comprise a chamber 210. In the illustrated embodiment, only a portion of a sidewall of the chamber 210 is illustrated in order to not obscure embodiments disclosed herein. It is to be appreciated that the chamber 210 may comprise a completely sealed volume in which a plasma (not shown) is generated.

In an embodiment, the sensor 230 may be located outside of the chamber 210. An optical path 235 from within the chamber 210 to the sensor 230 may pass through an optical coupling element. In the embodiment illustrated in FIG. 2A, the optical coupling element comprises a window 221. The window 221 passes through a portion of the chamber 210. For example, the window 221 may be located along a sidewall of the chamber 210. However, it is to be appreciated that the window may be located at any location of the chamber. In some embodiments, the window 221 may comprise an optically clear material to allow optical emissions from the plasma to pass through the chamber wall. In some embodiments, the window 221 may also comprise optics that enable focusing of the optical emissions propagated to the sensor 230 along the optical path 235.

Referring now to FIG. 2B, a partial perspective view illustration of a plasma processing system 200 is shown, in accordance with an additional embodiment. In an embodiment, the plasma processing system 200 in FIG. 2B may be substantially similar to the plasma processing system 200 in FIG. 2A, with the exception that the optical coupling element further comprises a fiber optic cable 222. The fiber optic cable 222 directly couples optical emissions from a plasma within the chamber 210 to the sensor 230. Such embodiments may allow for improved optical coupling compared to the use of just a window 221, as shown in FIG. 2A. In an embodiment, the fiber optic cable 222 may be coupled between a port in the chamber 210 and a port in the sensor 230.

Referring now to FIG. 2B, a partial perspective view illustration of a plasma processing system 200 is shown, in accordance with an additional embodiment. In an embodiment, the plasma processing system 200 in FIG. 2C may be substantially similar to the plasma processing system 200 in FIG. 2A, with the exception that the optical coupling element further comprises a fiber optic switching matrix 223. The fiber optic switching matrix 223 allows for a plurality of fiber optic cables 222_{A-C} to be optically coupled to the sensor 230 by a single fiber optic cable 222_{D}. In such an embodiment, the plurality of fiber optic cables 222_{A-C} may each be coupled to a port in the chamber 210. The optic switching matrix 223 provides an optical switching mechanism that allows for selecting which one of the plurality of fiber optic cables 222_{A-C} is optically coupled to the fiber optic cable 222_{D} and the sensor 230 at a given time. Accordingly, a plurality of different locations within the chamber 210 may be optically coupled to the sensor 230. This allows for spatial uniformity of the plasma to be determined.

In the illustrated embodiment, the plurality of fiber optic cables 222_{A-C} comprises three fiber optic cables. However, it is to be appreciated that any number of fiber optic cables 222 may be included in various embodiments. In some embodiments, the fiber optic cables 222 may be attached to ports through the chamber 210 located at a substantially uniform spacing around the perimeter of the chamber. Furthermore, while the fiber optic cables 222_{A-C} are coupled to the chamber 210 at an approximately uniform Z-height along the chamber wall, it is to be appreciated that in other embodiments, the fiber optic cables 222_{A-C} may be located at various Z-heights along the chamber wall.

Referring now to FIG. 2D, a partial perspective view illustration of a plasma processing system 200 is shown, in accordance with an embodiment. In an embodiment, the plasma processing system 200 comprises a plurality of plasma processing chambers 210. For example three plasma processing chambers 210_{A-C} are shown in FIG. 2D. However, it is to be appreciated that the plasma processing system 200 may comprise any number of plasma processing chambers 210. In an embodiment, each of the plasma processing chamber 210_{A-C} may be optically coupled to the sensor 230. For example, each of the plasma processing chambers 210_{A-C} may be optically coupled to an optic switching matrix 223 with fiber optic cables 222_{A-C}. The optic switching matrix 223 may be optically coupled to the sensor 230 with a fiber optic cable 222_{D}. Accordingly, a single sensor 230 may be used to detect optical emissions from a plurality of different plasma processing chambers 210.

Referring now to FIG. 2E, a partial perspective view illustration of a plasma processing system 200 is shown, in accordance with an additional embodiment. In an embodiment, the plasma processing system 200 in FIG. 2D may be substantially similar to the plasma processing system 200 in FIG. 2B, with the exception that the optical coupling element further comprises a filter bank 226. The filter bank 226 may comprise one or more optical filters 227_{A-C} that enable filtering or otherwise modifying the optical emissions prior to being sent to the sensor 230. The filter bank 226 may be optically coupled to the chamber 210 by a first fiber optic cable 222_{A} and optically coupled to the sensor 230 by a second fiber optic cable 222_{B}.

In an embodiment, the filter bank 226 may comprise a plurality of different optical filters 227_{A-C}. While three optical filters 227 are shown, it is to be appreciated that any number of optical filter 227 may be included in the filter bank 226. In other embodiments, the filter bank 226 may be configured to accept a single filter 227 that is manually switched out as needed. In some embodiments, the filter bank 226 may comprise mechanical supports (not shown) for inserting and retracting the filters 227 into and out of the optical path. The filter bank 226 may be operated automatically in coordination with the sensor 230, or the filter bank 226 may be operated manually. In an embodiment, the filters 227 may filter out selected wavelengths from the optical emissions from the plasma within the chamber 210. In other embodiments, the filters 227 may comprise polarizing filters.

Referring now to FIG. 3, a schematic diagram of a sensor 330 is shown, in accordance with an embodiment. In FIG. 3, only the dispersion gratings 331, 332 and the detector 333 are shown for simplicity. However, it is to be appreciated that the components may be housed in an housing, and the sensor 330 may also comprise additional optics components (e.g., mirrors, lenses, etc.) in order to focus the optical emissions.

In an embodiment, an optical emission 335 from a plasma may enter the cross-dispersion grating (e.g., by way of an optical coupling element such as those described above). The optical emission may be directed towards a first diffraction grating 331. In an embodiment, the first diffraction grating 331 may be oriented in a first direction, as indicated by the arrow. Optical emissions are diffracted by the first diffraction grating 331 along a first plane. That is, a diffracted optical emission 336 may be propagated towards a second diffraction grating 332.

In an embodiment, the second diffraction grating 332 may be oriented in a second direction, as indicated by the arrow. In an embodiments, the second direction is different than the first direction. In a particular embodiment, the second direction may be substantially orthogonal to the first direction. Accordingly, the second diffracted emissions 337 spread along a second plane as they are propagated towards the detector 333. Due to the cross-dispersion implemented by the first diffraction grating 331 and the second diffraction grating 332, the second diffracted emissions 337 intersect the detector 333 in a two dimensional plane. This is different than typical OES systems that use a single diffraction grating, and as such, only include an optical emission that intersects with the sensor along a one-dimensional line. In some embodiments, the sensor 330 may be an Echelle grating. In other embodiments, one of the first diffraction grating 331 or the second diffraction grating 332 may be replaced with an prism in order to provide similar spreading of the optical emissions. The use of a cross-dispersion grating sensor 330, therefore, allows for additional orders of diffraction to be obtained within a compact design. Depending on the construction of the gratings (e.g., spacing of the grating, etc.) the resolution may be at least 10 pm. In other embodiments, the resolution may be at least 100 fm.

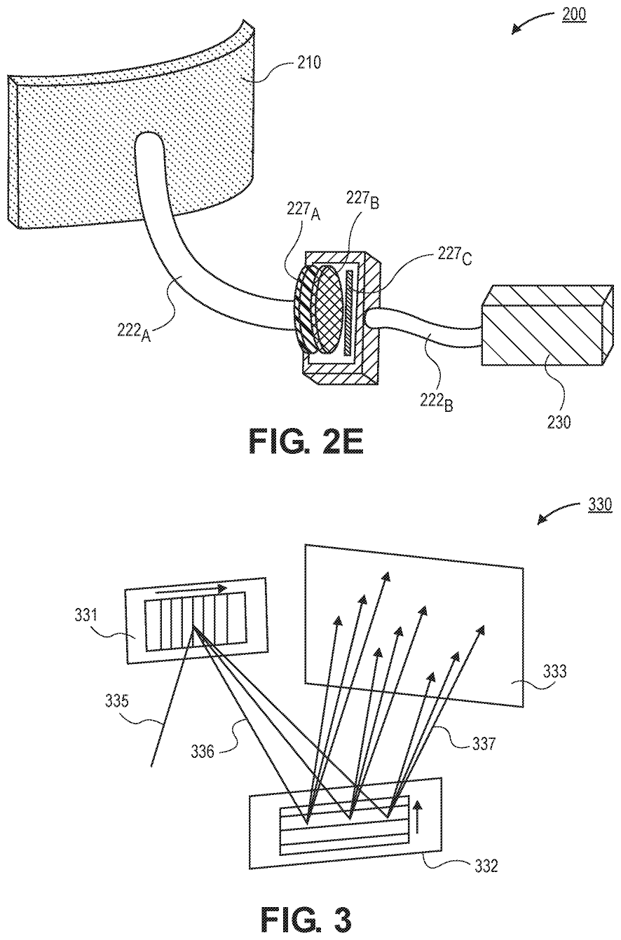

Referring now to FIG. 4, a cross-sectional illustration of a plasma processing system 400 is shown, in accordance with an embodiment. In an embodiment, the plasma processing system 400 may comprise a plasma chamber 410. A chuck 411 for supporting one or more substrates 412 may be included in the plasma chamber 410. During operation, a plasma 414 may be generated in the chamber 410 for processing the one or more substrates 412.

In an embodiment, an OES system with a cross-dispersion grating sensor 430, such as those disclosed herein may be included in the plasma processing system 400 in order to measure physical properties of the plasma 414 during operation. As shown, the sensor 430 may be optically coupled to a window 421 (or fiber optic port) through the chamber 410 wall with an optical coupling element 420. The optical coupling element 420 may comprise one or more of a window 421, fiber optic cables 422, or any other components such as those described above (e.g., filter banks, fiber optic switching matrices, etc.).

In an embodiment, the optical coupling element 420 may comprise optics for modulating the focus within the chamber 410. In an embodiment, the optics may comprise a lens capable of changing a focal point within the chamber 410. In other embodiments, the optics may comprise a mechanism for modulating a length of an optical path between the sensor 430 and the interior of the chamber 410. Accordingly, various focal points 415_{A-G} within the chamber 410 may be obtained. Scanning between various focal points 415 allows for plasma uniformity measurements to be obtained. That is, the OES system is capable of detecting properties of the plasma at various locations (e.g., center and edges). In the illustrated embodiment, seven different focal points 415 are shown. However, it is to be appreciated that any number of focal points may be used. In some embodiments, the focal points may be at any location within the chamber 410.

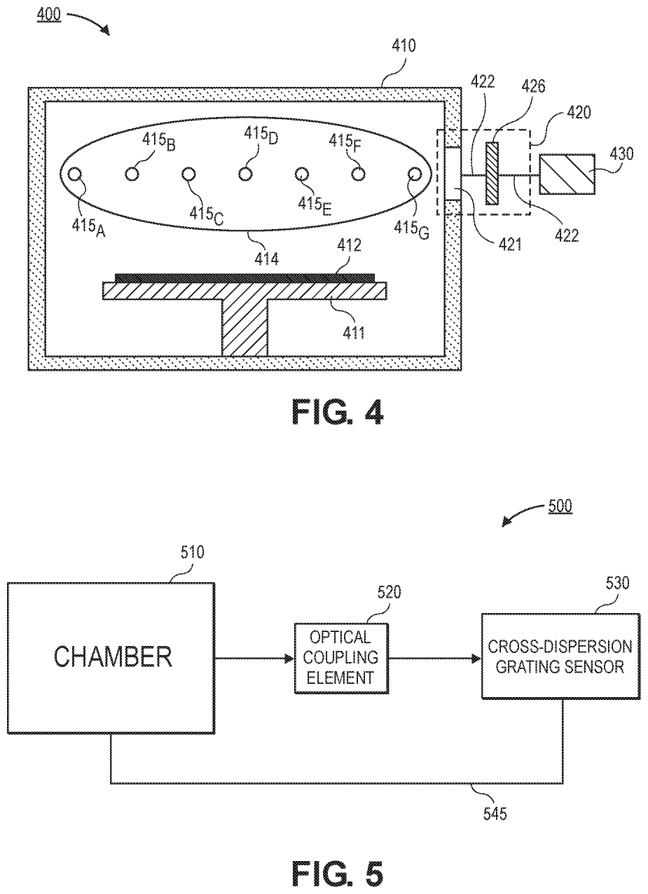

The detectors used in the cross-dispersion grating sensor 530 have two components, light amplification and readout. The internal light amplification can be as fast as 1 ns (1 GHz). The readout electronics limit the maximum time between acquired spectra. Typically, this falls between 0.1 Hz (CCD) and 100 Hz (CMOS). FIG. 5 shows a block diagram of a plasma processing system 500, in accordance with an additional embodiment. In this embodiment, an additional trigger switch 545 is included between the sensor 530 and the chamber 510. The trigger switch 545 synchronizes the light amplification aspect of the sensor 530 to a plasma operated in pulse mode which is typically between 0.1 and 100 kHz. This synchronization establishes a precise, controllable, relationship between the plasma pulsing and the data collection. This precise relationship both improves reading accuracy, and allows for investigation of transient plasma dynamics caused by the pulsed operation. In some embodiments, the detector readings may also be made using boxcar averaging in order to provide signal smoothing in order to account for the variations in the detector operating frequency and the plasma pulse frequency.

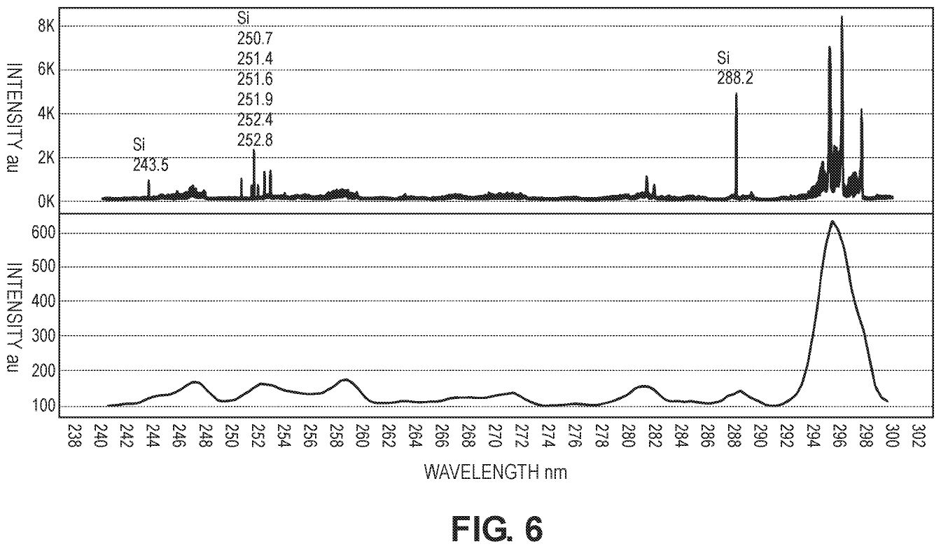

Referring now to FIG. 6, a plot of a plasma spectrum using an OES system with a cross-dispersion grating (top) in accordance with embodiments disclosed herein and an OES system using a standard spectrometer (bottom) is shown. As shown in the top plot, the cross-dispersion grating provides sufficient resolution to map the individual peaks in the emission spectrum. The same spectrum (as detected by a typical spectrometer) fails to identify many of the peaks. That is, groups of the peaks are merged together to form a single peak instead of having distinct transitions. For example, in the top spectrum, the silicon lines at 250.7 nm, 251.4 nm, 251.6 nm, 252.9 nm, 252.4 nm, and 252.8 nm are clearly visible, whereas in the bottom spectrum, there is no discernable differentiation between the peaks. Furthermore, some peaks in the top spectrum (e.g., 243.5 nm and 288.2 nm) are not discernable at all in the bottom spectrum.

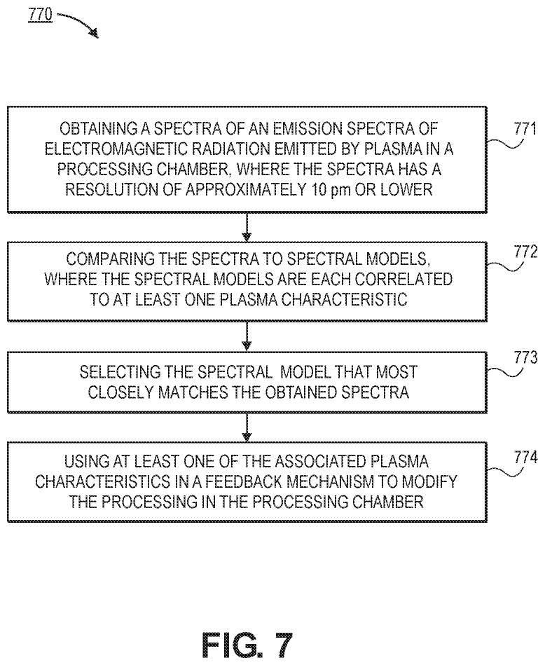

The improved resolution therefore allows for additional physical information from the plasma to be extracted. For example, a process 770 for obtaining and utilizing spectral plots with OES systems in accordance with embodiments disclosed herein is shown in FIG. 7. In an embodiment, process 770 includes obtaining a spectral plot of an emission spectra of electromagnetic radiation emitted by plasma in a processing chamber. In an embodiment, the spectral plot has a resolution of approximately 10 pm or lower, or approximately 100 fm or lower. The high resolution spectral plot may be obtained by using an OES system with a cross-dispersion grating, such as those disclosed herein. Accordingly, embodiments include providing a spectral plot with a resolution that is significantly improved over existing OES systems (which typically have a resolution limit of approximately 1 nm).

In an embodiment, operation 770 may continue with operation 772 which comprises an algorithm for comparing the spectra to spectral models. In an embodiment, the spectral models are each correlated to at least one plasma characteristic. For example, the plasma characteristics may include one or more of a gas temperature, plasma species density, etc. In an additional embodiment, operation 772 comprises an algorithm for recognition of time-dependent changes in the spectra.

In an embodiment, operation 770 may continue with operation 773 which comprises selecting the spectral model that most closely matches the obtained spectra. Accordingly, the plasma characteristics associated with the selected spectral model may be considered to be accurate representations of the plasma characteristics. In an additional embodiment, operation 773 comprises forming a history of spectral events from the time-dependent changes in the spectra.

In an embodiment, operation 770 may continue with operation 774 which comprises using at least one of the associated plasma characteristics or spectral events in a feedback mechanism to modify the processing in the processing chamber. For example, the accurate measurement of the plasma characteristics or spectral events may be used to refine plasma processing operations to improve process uniformity, accurately determine endpoint criteria, provide chamber matching, or any other useful operation for semiconductor manufacturing. In an embodiment, process 770 may be implemented in real time with the plasma processing operation in order to provide immediate (or near immediate) adjustment to the plasma processing operation. In other embodiments, the plasma characteristics or spectral events may be stored in a database for subsequent to the plasma processing operation is completed.

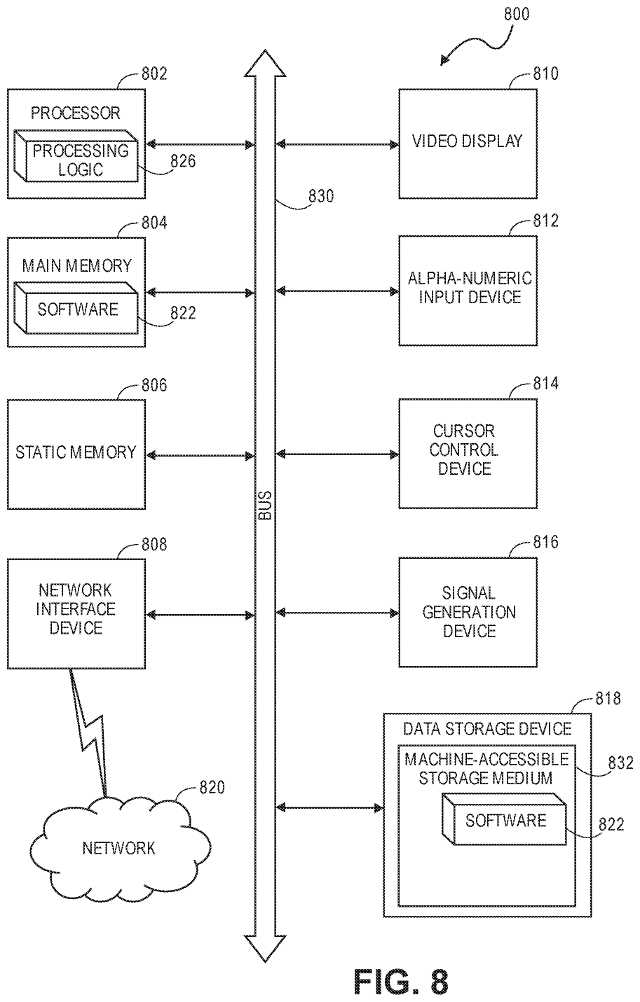

Referring now to FIG. 8, a block diagram of an exemplary computer system 860 of a processing tool is illustrated in accordance with an embodiment.

In an embodiment, computer system 860 is coupled to and controls processing in the processing tool and/or the cross-dispersion grating. Computer system 860 may be connected (e.g., networked) to other machines in a Local Area Network (LAN), an intranet, an extranet, or the Internet. Computer system 860 may operate in the capacity of a server or a client machine in a client-server network environment, or as a peer machine in a peer-to-peer (or distributed) network environment. Computer system 860 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 860, the term “machine” shall also be taken to include any collection of machines (e.g., computers) that individually or jointly execute a set (or multiple sets) of instructions to perform any one or more of the methodologies described herein.

Computer system 860 may include a computer program product, or software 822, having a non-transitory machine-readable medium having stored thereon instructions, which may be used to program computer system 860 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 860 includes a system processor 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a secondary memory 818 (e.g., a data storage device), which communicate with each other via a bus 830.

System processor 802 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 802 may also be one or more special-purpose processing devices such as an application specific integrated circuit (ASIC), a field programmable gate array (FPGA), a digital signal system processor (DSP), network system processor, or the like. System processor 802 is configured to execute the processing logic 826 for performing the operations described herein.

The computer system 860 may further include a system network interface device 808 for communicating with other devices or machines. The computer system 860 may also include a video display unit 810 (e.g., a liquid crystal display (LCD), a light emitting diode display (LED), or a cathode ray tube (CRT)), an alphanumeric input device 812 (e.g., a keyboard), a cursor control device 814 (e.g., a mouse), and a signal generation device 816 (e.g., a speaker).

The secondary memory 818 may include a machine-accessible storage medium 831 (or more specifically a computer-readable storage medium) on which is stored one or more sets of instructions (e.g., software 822) embodying any one or more of the methodologies or functions described herein. The software 822 may also reside, completely or at least partially, within the main memory 804 and/or within the system processor 802 during execution thereof by the computer system 860, the main memory 804 and the system processor 802 also constituting machine-readable storage media. The software 822 may further be transmitted or received over a network 820 via the system network interface device 808. In an embodiment, the network interface device 808 may operate using RF coupling, optical coupling, acoustic coupling, or inductive coupling.

While the machine-accessible storage medium 831 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

What is claimed is:

1. An optical sensor system, comprising:
a processing chamber;
a sensor, wherein the sensor comprises:
a first diffraction grating oriented in a first direction;
a second diffraction grating oriented in a second direction; and
a detector for detecting electromagnetic radiation diffracted from the first grating and the second grating; and
an optical coupling element, wherein the optical coupling element optically couples an interior of the processing chamber to the sensor.

2. The optical sensor system of claim 1, wherein the optical coupling element comprises a window passing through a surface of the processing chamber.

3. The optical sensor system of claim 1, wherein the optical coupling element comprises a fiber optic cable.

4. The optical sensor system of claim 1, wherein the optical coupling element comprises a fiber optic switching matrix.

5. The optical sensor system of claim 4, wherein a plurality of optical ports in the processing chamber are optically coupled to the fiber optic switching matrix.

6. The optical sensor system of claim 4, further comprising a plurality of processing chambers, wherein each of the plurality of processing chambers comprise an optical port, and wherein each optical port is optically coupled to the fiber optic switching matrix.

7. The optical sensor system of claim 1, wherein the optical coupling element comprises a filter bank.

8. The optical sensor system of claim 7, wherein the filter bank comprises a plurality of filters that are displaceable into and out of an optical path between the processing chamber interior and the sensor.

9. The optical sensor system of claim 1, wherein the first direction is substantially orthogonal to the second direction.

10. The optical sensor system of claim 9, wherein the sensor is an Echelle spectrometer.

11. The optical sensor system of claim 1, further comprising:
a trigger between the processing chamber and the sensor, wherein the trigger coordinates readings of the sensor with a frequency of a plasma in the processing chamber.

12. The optical sensor of claim 1, wherein the optical coupling element comprises variable optics.

13. The optical sensor of claim 12, wherein the variable optics provide a plurality of focal points within a volume of the processing chamber.

14. An optical sensor system, comprising:
an optical coupling element; and
a sensor that is optically coupled to the optical coupling element, wherein the sensor comprises:
a first diffraction grating oriented in a first direction;
a second diffraction grating oriented in a second direction, wherein the second direction is substantially orthogonal to the first direction; and
a detector for detecting electromagnetic radiation diffracted from the first grating and the second grating.

15. The optical sensor system of claim 14, wherein a minimum resolution of the sensor is at least 10 pm.

16. The optical sensor system of claim 14, wherein a minimum resolution of the sensor is at least 100 fm.

17. The optical sensor system of claim 14, wherein the sensor is an Echelle spectrometer.

18. A method of analyzing plasma characteristics, comprising:
obtaining an spectral plot of electromagnetic radiation emitted by a plasms in a processing chamber, wherein the spectral plot has a resolution of approximately 10 pm or lower;
comparing the spectral plot to spectral plot models, wherein the spectral plot models are each correlated to at least one plasma characteristic;
selecting the spectral plot model that most closely matches the obtained spectral plot; and
using at least one of the associated plasma characteristics or spectral events in a feedback mechanism to modify the processing in the processing chamber.

19. The method of claim 18, wherein the at least one plasma characteristic comprises gas temperature or species density.

20. The method of claim 18, wherein the spectral plot is obtained with a cross-dispersion grating.
